(19) United States
(12) Patent Application Publication
(10) Pub. No.: US 2016/0380512 A1
(43) Pub. Date: Dec. 29, 2016

(54) PEDAL GENERATOR ASSEMBLY

(71) Applicant: CATALYST DESIGN AND DEVELOPMENT, Port Louis (MR)

(72) Inventors: Sameer Hajee, Calgary (CA); Simon Nicolas Tremeer, Cape Town (ZA); Barry Martin Whitmill, Cape Town (ZA)

(21) Appl. No.: 15/191,016

(22) Filed: Jun. 23, 2016

Related U.S. Application Data
(62) Division of application No. 13/033,416, filed on Feb. 23, 2011, now abandoned.
(60) Provisional application No. 61/307,271, filed on Feb. 23, 2010.

(51) Int. Cl. H02K 7/18; H02K 11/20; A63B 22/06; A63B 21/22; A63B 21/00; A63B 71/06; H02K 7/116; H02J 7/00

(52) U.S. Cl. CPC H02K 7/1861; H02K 7/116; H02K 11/20; H02J 7/0045; H02J 7/0021; A63B 21/22; A63B 21/4034; A63B 71/0619; A63B 22/06; A63B 2071/0658; A63B 2022/0635

(57) ABSTRACT

A generator assembly for converting human generated mechanical energy into electrical power for charging at least one rechargeable device is provided herein. The generator assembly generally includes a housing, a primary gear supported within the housing, an input mechanism mounted to the primary gear for receiving the human generated mechanical energy, an alternator for converting the mechanical energy converting the mechanical energy into electrical power, and a charging mechanism mounted to the housing with the charging mechanism directly connected to the alternator, where the charging mechanism has at least one rechargeable interface for transferring the electrical power to the rechargeable device. A method of charging at least one rechargeable device with a generator assembly and a method of authorizing use of a generator assembly are also provided.

### CROSS-REFERENCE TO RELATED APPLICATIONS

The subject patent application claims priority to and all of the benefits of U.S. Provisional Patent Application Ser. No. 61/305,072, which was filed on Feb. 23, 2010, the entire specification of which is expressly incorporated herein by reference.

### FIELD OF THE INVENTION

The present invention relates to generator assembly, and more particularly to a generator assembly that is human-powered.

### BACKGROUND OF THE INVENTION

Multiple places around the globe either have shortages in electricity supply or no electricity supply at all. Developing countries typically have fragile economies and experience serious environmental problems, which are associated with and negatively affect the use of energy, thereby making energy unaffordable to people in need. Coal-fired and nuclear power stations for electricity generation, coal combustion in the townships, SASOL coal to oil processes, petrol and diesel use in vehicles for mass transportation, and over-exploitation of fuel wood resources all result in serious, long term environmental damage.

Many people in these developing countries still depend on inefficient traditional energy sources. The most common type of fuel for cooking or lighting in low-income homes is kerosene or wood or other biomass, such as dung and crop wastes. Burning these types of material damages health and has been associated with respiratory diseases and eye problems.

Alluding to the above, land degradation and deforestation continue to grow as people in need of fuel sources cut down trees for cooking meals and illuminating their homes. Women and children spend many hours looking for wood; therefore, electricity could free up their time for other activities. For example, electric lighting could extend study hours for children attending schools. Power for recharging multiple telecommunications devices and computers could also help facilitate such causes in off-grid environments.

As such, there is a constant need for a generator assembly that is cost effective, easy to manufacture, transport, assemble and operate, and which will eliminate one or more problems as set forth above.

### SUMMARY OF THE INVENTION

The present invention provides a generator assembly for converting human generated mechanical energy into electrical power for charging at least one rechargeable device. The generator assembly includes a housing defining a base and side walls. A primary gear is supported within the housing. An input mechanism is mounted to the primary gear for receiving the human generated mechanical energy. An alternator is mounted to the housing. The alternator has an output gear directly engaged with the primary gear to define a direct drive between the input mechanism and the alternator for directly transferring the human generated mechanical energy to the alternator with the alternator converting the mechanical energy into electrical power. The generator assembly further includes a charging mechanism mounted to the housing with the charging mechanism electrically connected to the alternator and having at least one rechargeable interface for transferring the electrical power from the alternator to the rechargeable device.

The present invention also provides a method of charging the at least one rechargeable device with the generator assembly. The method includes the steps of actuating the input mechanism to rotate the alternator to convert mechanical energy to electrical energy, displaying at least one charge rate indicator on the user interface with the at least one charge rate indicator corresponding to the amount of electrical energy transmitted from the rechargeable interface to each of the at least one rechargeable device, and signaling to a user through the user interface to adjust a rotational speed of the alternator.

The present invention also provides a method of authorizing use of a generator assembly. The method includes the steps of selling a virtual energy packet having at least one virtual energy unit with each virtual energy packet being coded to a single generator assembly through a virtual energy unit access code, delivering the virtual energy unit access code to a receiver unit, crediting the generator assembly with an energy credit amount associated with the virtual energy packet corresponding to the virtual energy unit access code delivered to the receiver unit, displaying a real-time remaining energy credit amount through the user interface, and locking the generator assembly when the remaining energy credit amount has been exhausted.

In accordance with the above, an advantage of the present invention is to provide a generator assembly that is cost effective and easy to manufacture. Another advantage of the present invention is to provide a human-powered generator assembly that is easily transportable, compact in its design and can be easily assembled, installed and operated to provide electrical power. Still another advantage of the present invention is to provide an inexpensive solution for many places in the world where electricity is in high demand and is either not available or not affordable.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a generator assembly in accordance with a first embodiment of the subject invention.

FIG. 2 is an exploded perspective view of the generator assembly of the first embodiment;

FIG. 3 is an enlarged perspective view of a primary gear, an input mechanism and an alternator in accordance with the subject invention.

FIG. 4 is a perspective view of the generator assembly of the subject invention mounted to a human-powered charging station.

FIG. 5 is a fragmented perspective view of the generator assembly being mounted to the charging station.

FIG. 6 is a perspective view of the generator assembly of the first embodiment with a plurality of rechargeable devices.

FIG. 7 is a plan view of one embodiment of a user interface for use with the generator assembly of the subject invention.

FIG. 8 is a perspective view of a generator assembly in accordance with a second embodiment of the subject invention.

FIG. 9 is an enlarged perspective view of another embodiment of a user interface for use with the generator assembly of the subject invention.

FIG. 10 is a flowchart illustrating a method of charging at least one rechargeable device with the generator assembly of the subject invention.

FIG. 11 is a flowchart illustrating a method of authorizing use of the generator assembly of the subject invention.

### DETAILED DESCRIPTION OF THE INVENTION

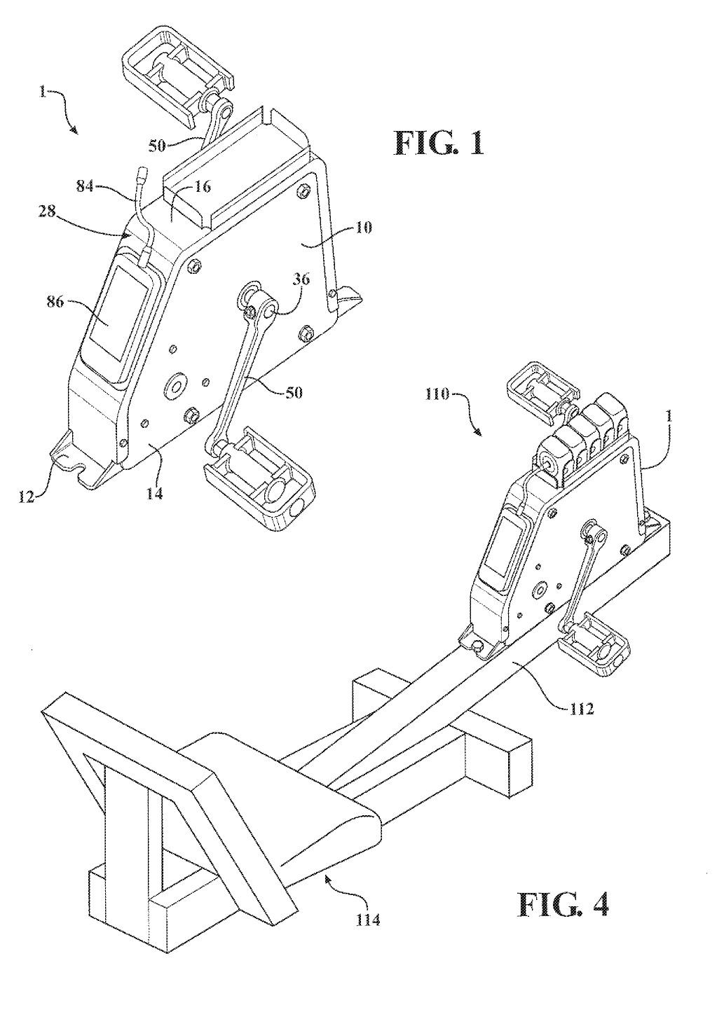

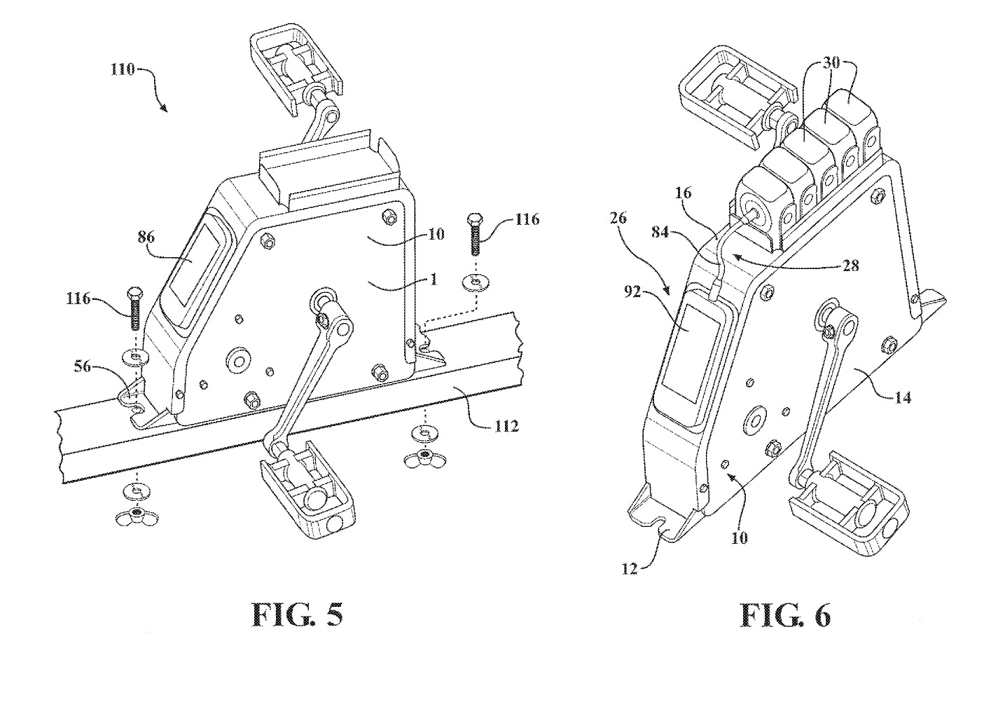

A generator assembly for converting human generated mechanical energy into electrical power for charging at least one rechargeable device is shown in FIG. 1. As will become apparent from the following description, the generator assembly may be utilized in a variety of applications. One such application is shown in FIGS. 4 and 5 and will be discussed in greater detail below.

Referring back to FIG. 1, the generator assembly 1 includes a housing 10 defining a base wall 12 and side walls 14. In particular, the generator assembly 1 includes a plurality of side walls 14 and also a top wall 16. The side walls 14 and top wall 16 are joined to the base wall 12 to form an enclosure. The top wall 16 has an oblique, generally rearward facing portion. The housing 10 may be plastic, metal, wood, or other suitable materials.

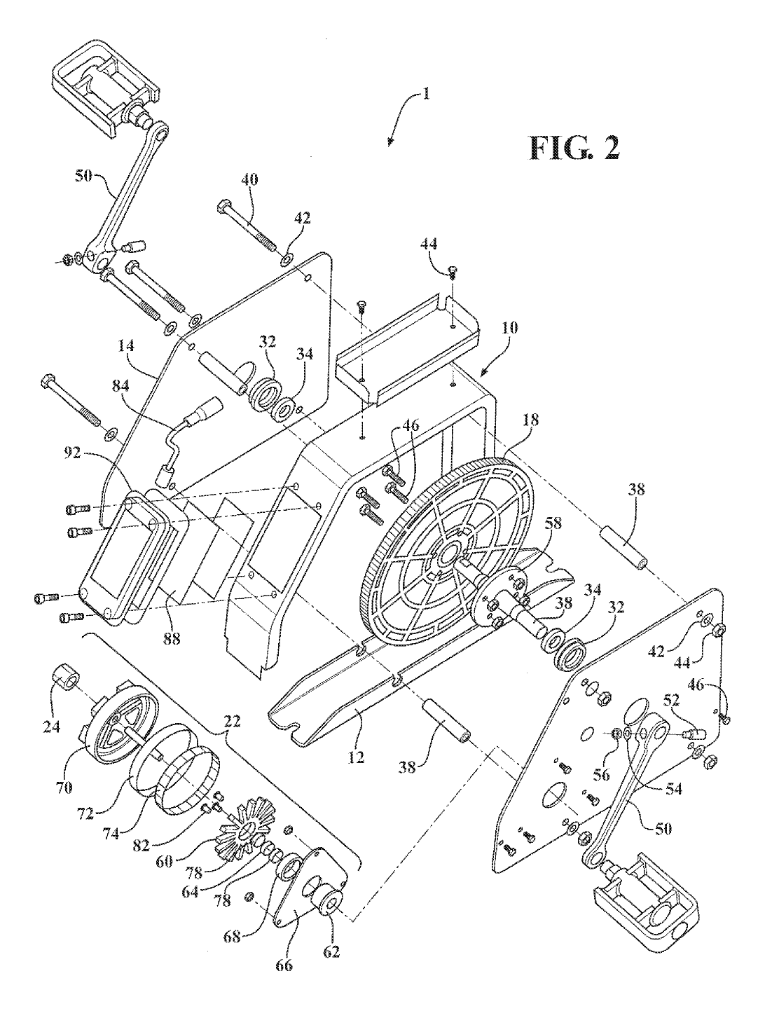

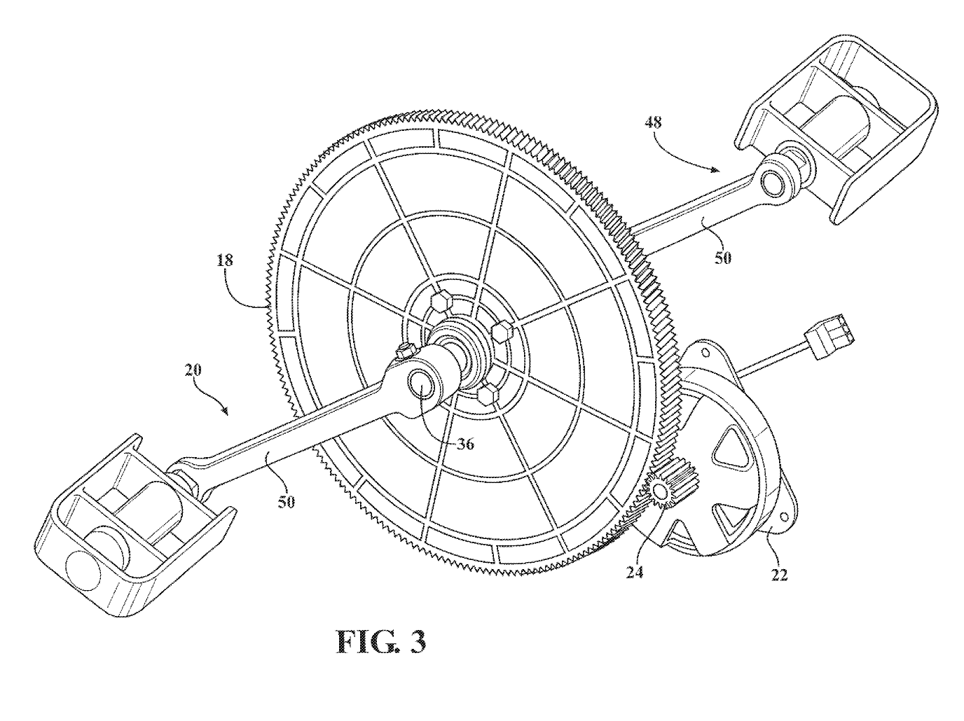

Referring also to FIGS. 2 and 3, a primary gear 18 is supported within the housing 10. The housing 10 allows the primary gear 18 to rotate freely. An input mechanism 20 is mounted to the primary gear 18 to receive the human generated mechanical energy. The side walls 14 preferably each include a hole in order to allow the input mechanism 20 to mechanically engage the primary gear 18. The primary gear 18 further comprises an input shaft 36. The input shaft 36 extends through the plurality of side walls 14 and engages the input mechanism 20, such that upon activation of the input mechanism, the input shaft 36 is rotated. The rotation of the input shaft 36 rotates the primary gear 18. Affixed to input shaft 36 is an input gear flange 58. The input gear flange 58 is affixed to the primary gear 18 with nuts and bolts. The primary gear 18 may be injection molded of a plastic material or equivalent material. The primary gear 18 is preferably self-lubricating, but auxiliary lubricating systems are also contemplated. As illustrated, the housing 10 includes bearing holders and deep groove bearings 34 to support the input shaft 36 in the side walls 14. Spacer bars 38 extend between and space the side walls 14 from each other. Housing bolts 40 extend through and retain the housing washers 42, side walls 12, spacer bars 38 and housing nuts 44. Housing screws 46 secure the parts of housing 10 together.

In the embodiment as shown, the input mechanism 20 is further defined as a pedal system 48 having two pedal shafts 50 each connected to the primary gear 18 along the input shaft 36. As such, rotation of the pedal system 30 causes rotation of the primary gear 18. The pedal shafts 50 may be right and left pedal shafts. Preferably, the pedal shafts 50 are secured to each opposite end of input shaft 36.

As shown in FIG. 2, the pedal shafts 50 are secured to the input shaft 36 with pins 52, washers 54 and nuts 56. The left and right pedals may be marked with an “R” for right, having right-hand thread and with an “L” for left, having left-hand thread, as is well-known in the relevant art.

The primary gear 18 is in engagement with an output gear 24 of an alternator 22 as discussed further below. The materials used in at least one of these gears 18, 24 have been specifically chosen so that there is reduced wear between these components. Gears 18 and/or 24 may, for example, be made of acetyl, or nylon, or another suitable material. The preferred self-lubricating properties avoid the need for oil-based lubricants, which can collect dust dirt and adversely affect wear, and the attendant lubricating service requirements.

It should be appreciated that other pedal systems are contemplated for use with the generator assembly 1 described herein. Further, although a pedal system 48 is described through the instant disclosure, it is also contemplated that the input mechanism 20 may be any other suitable device for converting human energy into mechanical energy, such as a pump, a lever, a hand cycle, and other devices as is appreciated by one of ordinary skill.

An alternator 22 is mounted to the housing 10 with the alternator 22 having an output gear 24 directly engaged with the primary gear 18 to define a direct drive between the input mechanism 20 and the alternator 22 for directly transferring the human generated mechanical energy to the alternator 22 which converts the mechanical energy into electrical power. The alternator 22 is mounted to the housing 10 and includes the output gear 24 directly engaged with the primary gear 18 to define the direct drive between the input mechanism 20 and the alternator 22.

As best shown in FIG. 2, the alternator 22 includes a stator stack and windings 60 along with a stator post 62 and a bearing spacer 64. A stator plate 66 is fixed to the housing 10 by screws and nuts. The alternator 22 also includes a spacing ring 68, a rotor cup 70, a back iron 72, magnet 74 and rotor shaft 76. The rotor shaft 76 is supported on deep groove bearings 78 and a bearing spacer 80 is disposed within the stator post 62. Button head cap screws 82 retain the axially arranged alternator components together. It is also contemplated that the alternator 22 includes other components, as will be appreciated by one of ordinary skill

In one configuration, the alternator 22 is a three-phase alternator. However, it is also contemplated that other types of alternators may be used in conjunction with the generator assembly 1 described herein. The three-phase alternator 22 provides many benefits over traditional alternator configurations. Particularly, if the operator of the generator assembly 1 pedals too fast and the power output increases to above a specified level, the three-phase alternator 22 allows these phases to be kicked out sequentially until there is only one phase and all the power from this one phase may be dissipated into a resistor specifically chosen to handle this load. This may be accomplished with electronic circuitry that is connected to and controls the operator of the three-phase alternator 22.

In one configuration, only one phase of the alternator is dropped if the current exceeds the set limit for longer than 1, 5, 10, 15, or 20 seconds. At this point, if the generator assembly 1 is pedaled further, all three phases are cut, and the operator has to stop pedaling before the three phases will re-engage. Thus, the three phase alternator 22 ensures that any rechargeable devices which are connected to the generator assembly 1 are not overcharged or damaged because too much current is transmitted to their internal batteries.

As discussed above, the generator assembly 1 uses a single stage, precision, step-up gear system having the primary gear 18 and the output gear 24 fixed to the alternator 22. The gear train utilizing the primary gear 18, input mechanism 20, and the output gear 24 (as opposed to conventional chain/belt and sprocket/pulley drive trains) enables the alternator 22 to turn at high output speed while the operator pedals at a slow and comfortable input speed. The gear train is disposed within the compact, simple and rugged housing 10.

In certain embodiments of the generator assembly 1, the input-output ratio of the primary gear 18 to the output gear 24 is 1:10, which cannot be efficiently and simply achieved by using conventional chain/belt and sprocket/pulley drive trains. The high gear ratio allows for the user to pedal at a comfortable pace yet the alternator 22 is turning at a high optimal speed. Because there is less energy loss through a geared drive train as opposed to conventional chain/belt and sprocket/pulley drive trains, less precious human energy is lost in the conversion to electrical energy. In order to achieve such gear ratios, the primary gear 18 has a diameter of at least 2, 3, 4, 5, 6, 7, 8, 9, or even 10 times larger than the diameter of the output gear 24.

As the alternator 22 converts mechanical energy to electrical power, the electrical power is sent to a charging mechanism 26. The charging mechanism 26 is mounted to the housing 10, and is electrically connected to the alternator 22. The charging mechanism 26 may be affixed to the top wall 16 with housing screws and rivets 46. The charging mechanism 26 is capable of transmitting electrical power to on or more rechargeable devices. The charging mechanism 26 has at least one rechargeable interface 28 for transferring the electrical power to the rechargeable device(s). The charging mechanism 26 and rechargeable interface 28 are discussed in greater detail below.

As shown in FIGS. 4 and 5, the generator assembly 1 is designed to be versatile and be mounted to any suitable platform or station, which is typically, constructed on-site using local materials. As one example, the generator assembly 1 may be mounted to a human-powered charging station 110. The human-powered charging station 110 includes an elongated beam 112 and a seat 114. On one end of the elongate beam 112, the seat 114 is placed. Near the opposite end of the beam 112 is the generator assembly 1, which is secured to beam by means of bolts 116.

Specifically, the base wall 12 of generator assembly 1 is affixed to the elongate beam 112 using two bolts 116 and their associated wing nuts and washers, such that the display 92 faces the operator when seated in the seat 114 affixed to the beam 112. The seat 114 is located rearward of generator assembly 1 and the operator thus faces forward when pedaling the human-powered charging station 110. The recumbent design of the seating of the human-powered charging station 110 is proven to maximize human energy input. Another feature which speaks to maximizing the electrical energy derived from human input, is that operators of differing stature can be optimally accommodate by affixing the generator assembly 1 at various points along the length of the elongate beam 112. In this example, the station is relatively simple in its construction and is made of wood.

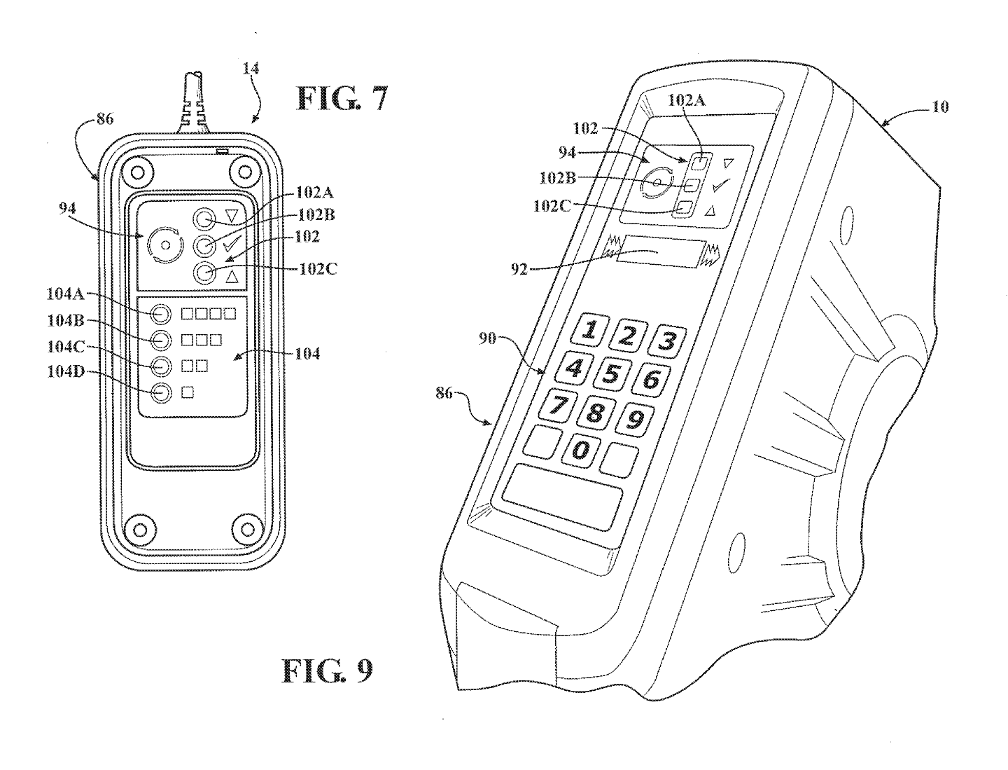

Turning to FIGS. 6 and 7, a charging mechanism 26 is mounted to the housing 10 with the charging mechanism 26 electrically connected to the alternator 22 and having at least one rechargeable interface 28 for transferring the electrical power from the alternator 22 to a rechargeable device 30. As shown in FIG. 6, the rechargeable interface 28 carries an accommodated number of devices or units 30 to be charged by generator assembly 1. In one configuration, the rechargeable interface 28 comprises at least one charging cable 84 configured to connect to at least one rechargeable device 30. Preferably, the charging cable 84 includes a male connector extending from it, which is received into the female connector of a rechargeable device 30. Alternatively, other ways of transmitting the electrical power from the rechargeable interface 28 to the rechargeable devices 30 are also contemplated, such as contact-driven charging, port-battery charging, and other charging methods that will be appreciated by one of ordinary skill It is also contemplated that as one of the rechargeable devices 30 is charged, power can be transmitted through that rechargeable device 30 to other rechargeable devices 30, which are mechanically or electrically engaged with each other in series.

As shown in FIG. 7, the generator assembly 1 includes a user interface 86. In one embodiment, the top wall 16 has an oblique, generally rearward facing portion having an aperture in which is disposed the user interface 86. The user interface 86 may include a sticker or label to identify its indicators, and may include a gasket about its periphery. The back of the user interface 86 may be defined by a shield plate. Between the gasket and shield plate, a printed circuit board (PCB) assembly 88 may be provided, see FIG. 2.

The user interface 86 can include an effort indicator 94 having at least one pedaling speed light 102 and at least one timing light 104. Alternatively, the effort indicator 94 may include only the pedaling speed lights 102 or just the timing lights 104. As illustrated, the pedaling speed lights 102 include a red light 102A for indicating that the operator is pedaling too fast, a green light 102B for indicating that the operator is pedaling at the correct speed and a yellow light 102C for indicating that the operator is pedaling too slowly.

The user interface may also include timing lights 104. As one non-limiting example, light 104A indicates that the operator has been pedaling for the amount of time to achieve complete charge of rechargeable device(s) 30, which may be approximately 20 minutes, depending on the embodiments of generator assembly 1 and rechargeable device(s) 30. Light 104B indicates that the operator has been pedaling for the amount of time to achieve complete about three quarters charge of rechargeable device(s) 30, which may be approximately 15 minutes. Light 104C indicates that the operator has been pedaling for the amount of time to achieve about one half charges of rechargeable device(s) 30, which may be approximately 10 minutes. Finally, light 104D indicates that the operator has been pedaling for the amount of time to achieve about one quarter charge of rechargeable device(s) 30, which may be approximately 5 minutes.

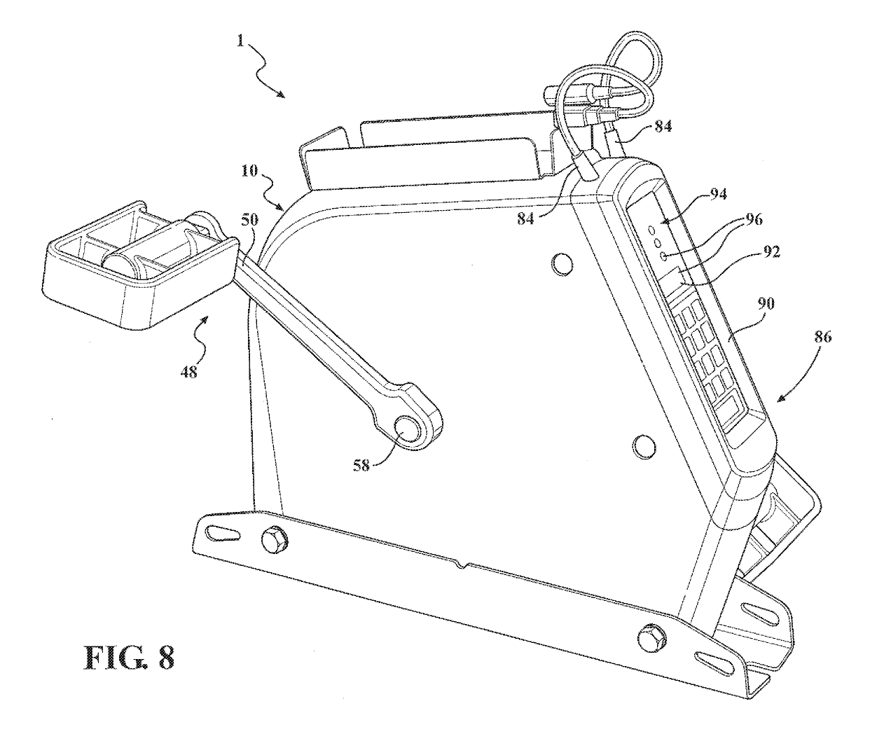

Turning to FIGS. 8 and 9, a second embodiment of the generator assembly 1 is shown. Many of the primary features of the generator assembly 1 shown in FIGS. 8 and 9 are similar or identical to the generator assembly 1 shown in FIGS. 1-6. As is readily apparent, the shape and configuration of the housing 10 has been revised in the second embodiment. In particular, the housing 10 in this embodiment is more contoured and is preferably formed of plastic. The charging mechanism 26 is also updated in the second embodiment. One feature includes the addition of a second charging wire. Also, the user interface is updated.

In the embodiment of FIGS. 8 and 9, the user interface 86 includes a key pad 90 and a display 92. The display 92 may comprise a LED screen or an LCD screen, or other display type as will be appreciated by one of ordinary skill In one configuration, the user interface 86 comprises an effort indicator 94 having a signaling device 96 indicating whether a user should adjust or maintain a rotation speed of the pedal system or other input mechanism. The display 92 may further include at least one charge rate indicator configured to detect and display an amount of current or energy units being transmitted from the rechargeable interface 28 to each of the rechargeable devices 30. The user interface 86 is operator-monitored and shows, by illuminated LEDs, the optimum pedaling speed (the correct input current) and the duration and progress of required pedaling time (based on the pedaling speed) to recharge the connected rechargeable device(s) 30.

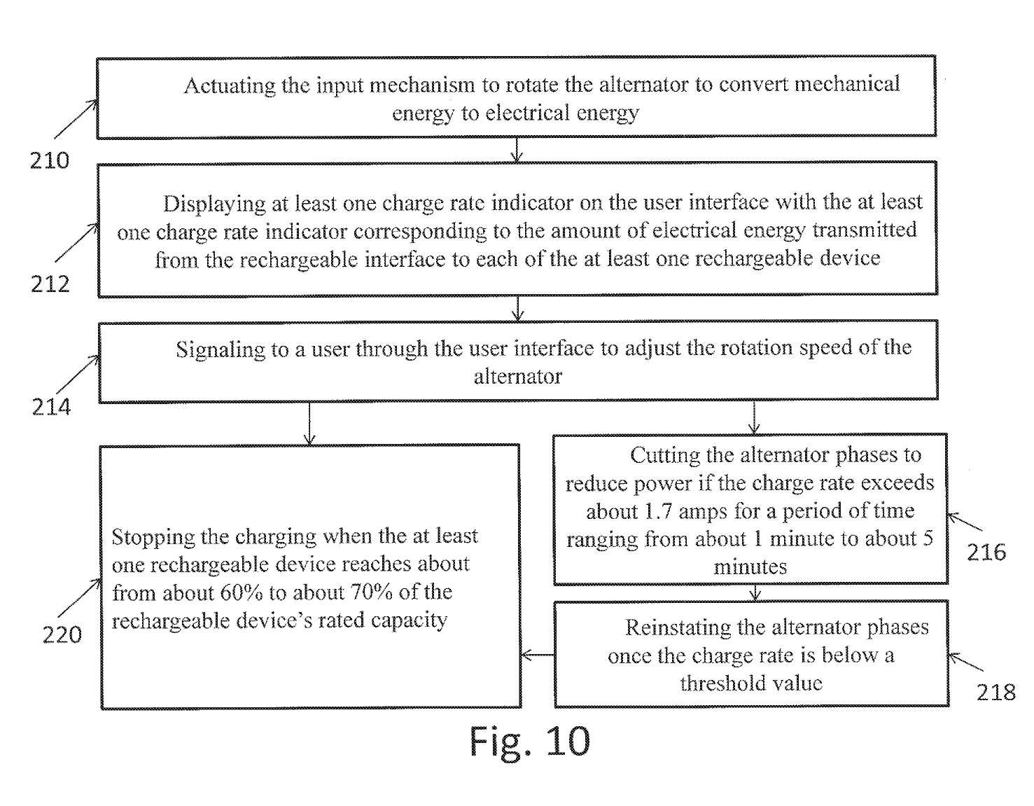

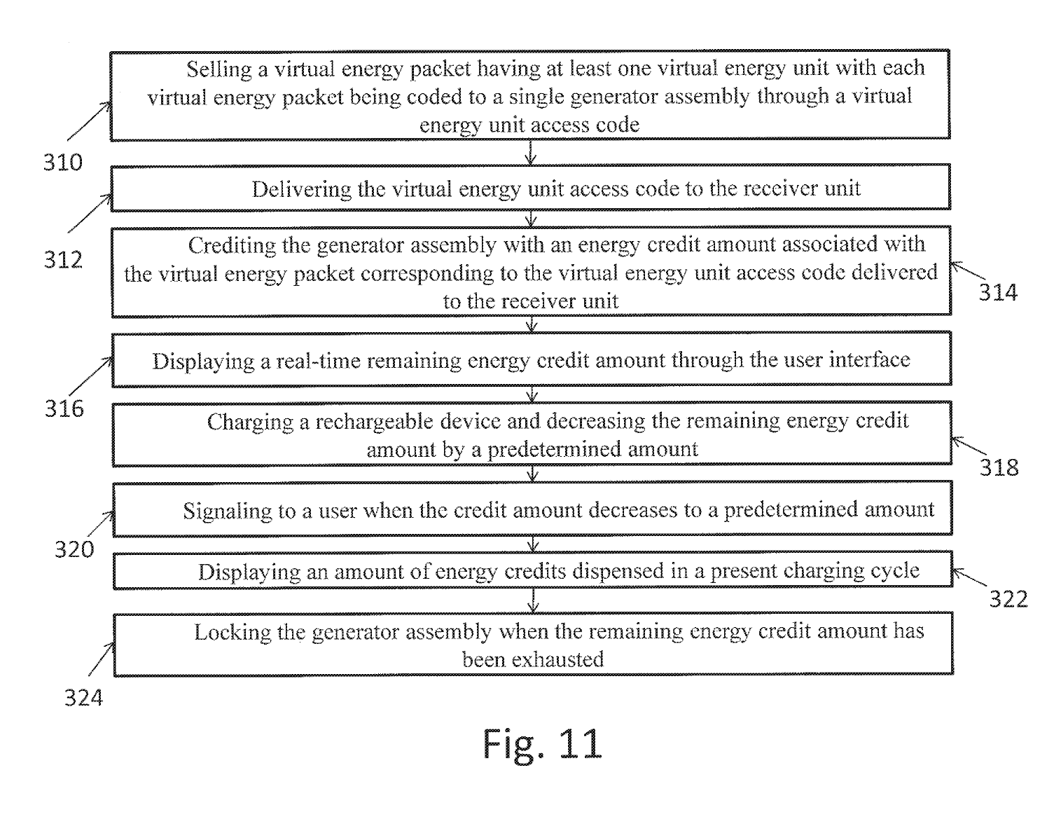

Referring to FIG. 10, a method of charging at least one rechargeable device 30 is also provided. The method includes the steps of (210) actuating the input mechanism 20 to rotate the alternator 22 to convert mechanical energy to electrical energy, (212) displaying at least one charge rate indicator on the user interface 86 with the at least one charge rate indicator corresponding to the amount of electrical energy transmitted from the rechargeable interface 28 to each of the at least one rechargeable device 30 and (214) signaling to a user through the user interface 86 to adjust the rotation speed of the alternator 22.

In one embodiment, the step of signaling the user through the user interface 86 to adjust the rotation speed of the alternator 22 comprises displaying a symbol on the user interface 86 indicating increasing, decreasing, or maintaining the rotation speed of the alternator 22.

If the operator pedals too slowly, the yellow pedaling speed light 102C shines, and the operator should speed up the rate of pedaling. If the operator maintains a pedaling rate that is too slow, a longer period of time will be necessary to recharge the connected rechargeable device(s) 30.

If the operator pedals too fast, the green correct speed light 102B goes off and the red pedaling speed light 102A shines. The operator should then slow down until the green light 102B shines again.

Each of the pedaling lights may be provided in a frame that is indicative of the meaning of the signal. For example, the red pedaling speed light 102A may be provided in an octagon shaped frame or a down arrow shape. Similarly, the green pedaling speed light 102B may be provided in a circle. Furthermore, the yellow pedaling speed light 102C may be provided in an up arrow shape. The green light frame may be provided in between the red pedaling speed light frame and the yellow pedaling speed light frame, such that the user can clearly comprehend whether their pedaling speed is too high, too low, or within the desired speed range.

For example, if a rechargeable light is the device 30 and is ready for recharge, the light will shine for a few seconds and then go off or will not shine at all. Some lights may be electrically connected together and from one to a maximum of five accommodated lights 30 can be recharged at one time. The light(s) 30 may be placed in the rechargeable interface 28 on the top of the generator assembly 1. The light(s) 30 may be plugged into the charging cable 84. If the light(s) are correctly connected, the bottom timing light 104D will flash and the yellow pedaling speed light 102C will shine.

In order to begin charging, the operator pedals the generator assembly 1. If the operator pedals at an appropriate speed, the green pedaling speed light 102B will shine solidly. The operator would preferably maintain this speed. For example, in certain embodiments of the generator assembly 1 and type of rechargeable devices 30 being charged, a particular first appropriate speed corresponds to a first accommodated number of rechargeable devices 30 being charged. Corresponding to the recharging of a second, lower number of accommodated rechargeable devices 30, is a lower second speed. As a particular example, when recharging five lights 30 the correct speed is approximately 60 rpm. When recharging only one light, the correct speed is much slower.

In another possible configuration, the step of signaling the user through the user interface 86 to adjust the rotation speed of the alternator 22 is further defined as audibly signaling a user to increase or decrease the rotation speed of the alternator 22. In such a configuration, the generator assembly 1 may comprise a noise generating device as understood by one of ordinary skill in the art. Audibly signaling a user may comprise playing a voice or sound which is indicative of whether the user needs to increase, decrease, or maintain their pedaling speed.

Certain embodiments of the generator assembly 1 and the rechargeable devices 30 may take approximately 20 minutes of pedaling to recharge. The charge time may be substantially constant regardless of the accommodated number of rechargeable devices 30 connected to the generator assembly 1.

In one embodiment, after every five, ten, or fifteen minute period of pedaling, a timing light 104D will shine solidly, indicating that the operator may stop pedaling for a rest. The generator assembly 1 will only keep time when the operator is pedaling. It is also contemplated that the generator assembly 1 may keep time even if the user stops pedaling, as long as the rechargeable devices 30 remain connected. The generator assembly may derive operating power from the rechargeable devices 30, as in one configuration; the generator assembly does not include an internal battery.

When all of the timing lights 104 are shining solidly, the recharge is complete. That is, when charging is complete, all timing lights 104 shine solidly, and the generator assembly 1 will cut out. Pedaling will suddenly become loose, at which time the operator can stop pedaling. The charging cable 84 connected to the rechargeable devices 30 charged by the generator assembly 1 can then be unplugged. The rechargeable devices 30 may then be removed from the generator assembly 1 and utilized for powering their respective rechargeable devices 30. When all the lights on the display 92 have gone out, more rechargeable devices 30 may then be recharged.

Charging at least one rechargeable device 30 through the rechargeable interface 28 includes charging the at least one rechargeable device(s) 30 at rate ranging from about 10% to about 250%, 15% to about 225%, or from about 175% to about 225% or about 180% to about 220% or about 190% to about 210% of the at least one rechargeable device's 30 rated capacity. In one embodiment, the rated capacity is understood to mean the manufacturer's recommended charging rate. Thus, if the rated capacity is 0.85 Ah, the generator assembly 5 may charge the rechargeable devices at about 1.7 A. It is also contemplated that the charging rate may be adjusted to pertain to the rechargeable device 30 connected to the generator assembly.

Other charging systems may use a trickle charge system, which charges at about 10% of the manufacturer's recommended charging rate. Such a trickle charge system takes a significant amount of time, and thus is not sufficient for many applications.

The inventors have surprising realized that this increased charging rate beyond the rechargeable devices 30 rated charging rate may potentially lead to damage of the rechargeable devices 30 if the rechargeable devices 30 are charged beyond about ⅔ of their capacity at the increased rate. However, if the rechargeable devices 30 are not completely charged, the batteries of those devices are not damaged. Thus, the method may further comprise the step of (220) stopping the charging when the at least one rechargeable device 30 reaches about from about 50% to about 80%, 60% to about 70%, or about 66% of the rechargeable device's 30 rated capacity.

By stopping the charging before the device exceeds about 70% of the rechargeable device's rated capacity; the generator assembly can quickly charge the rechargeable devices without causing long term damage. Furthermore, there is no need for expensive equipment that monitors temperature, current, and voltage, as such equipment is only necessary to complete a charge beyond about 70% of the device's rated capacity.

The generator assembly 1 provides a safety cut-out by which, if the operator pedals too fast for too long (an amount that may trigger the red pedaling speed light 102A to shine), the generator assembly 1 will stop recharging the units 30. Pedaling will suddenly become loose. Even if the operator slows down pedaling now, the red pedaling speed light 102A will not go off and the charging will not resume immediately.

Beyond stopping the charging of the rechargeable devices 30, the method of charging at least rechargeable device may also include the step of (216) cutting the alternator phases to reduce power if the charge rate exceeds about 1.7 amps for a period of time ranging from about 1 second to about 20 seconds or from about 3 seconds to about 15 seconds, or from about 5 seconds to about 15 seconds, or about 10 seconds. Alternatively, it is also contemplated that the alternator phases may be cut if the charge rate exceeds about 1.1, 1.2, 1.3, 1.4, 1.5, 1.6, 1.8, 1.9, 2.0, or 2.1 amps for a predefined time period mentioned above.

The method may further include the step of (218) reinstating the alternator phases once the charge rate is below a threshold value. This reinstatement can be automatically triggered by the generator assembly 1. The operator should then stop pedaling until the red pedaling speed light 102A is no longer illuminated and the yellow pedaling speed light 102C shines. The operator may then resume pedaling.

The method of charging at least one rechargeable device may further include the step of displaying a remaining energy credit amount through the user interface 32.

Referring to FIG. 10, a method of authorizing use of a generator assembly 1 is also contemplated. The method may be used with the generator assembly 1 as defined in the instant disclosure. The generator assembly 1 may further comprise a receiver unit. The receiver unit may comprise a cellular or radio receiver. The receiver unit may be integrated into the generator assembly 1 itself, or may be provided as an external component, such as a mobile device. The receiver unit will receive a signal from energy mainframe system, which distributes virtual energy packets to a plurality of receiver units.

The method includes selling a virtual energy packet having at least one virtual energy unit (310). The sales of the virtual energy packets may be conducted from an electronic energy distribution system, as will be appreciated by one of ordinary skill The electronic energy distribution system may be web based or networked, to connect to a plurality of generator assemblies.

Each virtual energy packet may be coded to a single generator assembly 1 through a virtual energy unit access code. The coding of the virtual energy packet allows the packet to be used with only one generator assembly 1. By entering the unique identifier of the particular generator assembly 1 when purchasing the virtual energy unit, the energy distribution system automatically generates a virtual energy access code. The virtual energy access code may be encrypted, such that it may be not be hacked or manipulated to allow unauthorized access to virtual energy packets.

The method also includes (312) delivering the virtual energy unit access code to the receiver unit and (314) crediting the generator assembly 1 with an energy credit amount associated with the virtual energy packet corresponding to the virtual energy unit access code delivered to the receiver unit, and (316) displaying a real-time remaining energy credit amount through the user interface 86.

Delivery of the virtual energy unit access code to the receiver unit may occur through radio or cellular waves. If receiver unit is in the form of a mobile device, such as a cell phone, the virtual energy unit access code may be sent in the form of a text message. Alternatively, the virtual energy unit access code may be sent as an email to a user's email address. If the receiver unit is integrated into the generator assembly 1, delivery of the virtual energy unit access code to the receiver unit may include digitally or electronically providing the access code.

The virtual energy unit access code is coded to the purchase of a particular virtual energy packet. If the receiver unit is integrated in the generator assembly 1, the purchase of a virtual energy unit packet sends the virtual energy unit access code to the receiver unit, which provides an energy credit amount to the generator assembly 1. Once the virtual energy unit access code is received and processed by the generator assembly, the generator assembly 1 displays a real-time remaining energy credit amount through the user interface 32.

If the receiver unit is provided as a separate device, such as a mobile phone, the method may also comprise entering the virtual energy unit access code into a keypad 90 of the user interface 86. The user interface 86 may verify the entered virtual energy unit access code with a remote database. Once the virtual energy unit access code has been verified, the user interface 86 may communicate with the generator assembly 1. Once the virtual energy unit access code is received and processed by the generator assembly 1, the generator assembly displays a real-time remaining energy credit amount through the user interface 86.

The method may also include (324) locking the generator assembly 1 when the remaining energy credit amount has been exhausted. The generator assembly 1 may be locked through an on-board software protocol that limits operation when the remaining energy credit amount reaches zero or some other threshold amount. Alternatively, the generator assembly 1 may be locked remotely through activation of the receiver unit from an energy distribution system.

The method of authorizing use of a generator assembly 1 may further include the step of (318) charging a rechargeable device and decreasing the remaining energy credit amount by a predetermined amount. The energy credits may be equivalent to the number of devices being charged, an amount of time, or an amount of charge. For example, 1 energy credit may be equivalent to one device or 10 minutes of charge time or 10 W of power. When a rechargeable device 30 is connected and charged with the generator assembly 1, the remaining energy credits are decreased in proportion to the predetermined amount.

The method of authorizing use of a generator assembly 1 may further include the step of (320) signaling to a user when the remaining energy credit amount decreases to a predetermined amount. The signaling to a user may include a visual or audible signal, such as a flashing light, a beep, a textual message, or other easily comprehended signal. Signaling a user may be performed at any number of credit amount thresholds. It is also contemplated that the signaling may be preformed at a customizable set point, as preferred by the individual user of the generator assembly 1. The signal may be conveyed via the display 92 of the user interface 86.

The method of authorizing use of a generator assembly may also include the step of (322) displaying an amount of energy credits dispensed in a present charging cycle. The user interface 86 may display the amount of energy credits dispensed as the units are being dispensed in a real time fashion. Alternatively, the user interface 86 may display the amount of energy credits dispensed after charging of the rechargeable device has been completed. The amount of energy credits dispensed may be indicated on the display 92.

The generator assembly 1 and methods described herein may be used with a variety of rechargeable devices 30. Preferably, the generator assembly 1 directly charges the battery of each rechargeable device 30, and does not carry its own internal battery. Each rechargeable device 30 may include a radio, an air conditioning element, a fan, a watch with alarm mechanism, and any other device used for household purposes. The generator assembly 1 has been designed to charge directly into the internal battery of the rechargeable device 30 being charged. Such devices 30 may include, for example, lights, mobile phones, other types of rechargeable devices, and stand alone lead acid batteries. Other, prior pedal generators store generated power in an intermediate lead acid battery before charging other devices. By not requiring an intermediate battery in the generator assembly 1, energy losses between human input and the rechargeable device 30 to be recharged is minimized, and makes the generator assembly 1 more environmentally friendly than prior art generators. It also makes the generator assembly a more versatile product in the third world context, enabling it to power rechargeable products as well as efficiently recharge large lead acid storage batteries.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A generator assembly for converting human generated mechanical energy into electrical power for charging at least one rechargeable device, said assembly comprising:
a housing defining a base and side walls;
a primary gear supported within said housing;
an input mechanism mounted to said primary gear for receiving the human generated mechanical energy;
an alternator mounted to said housing with said alternator having an output gear directly engaged with said primary gear to define a direct drive between said input mechanism and said alternator for directly transferring the human generated mechanical energy to said alternator with said alternator converting the mechanical energy into electrical power; and
a charging mechanism mounted to said housing with said charging mechanism electrically connected to said alternator and having at least one rechargeable interface for transferring the electrical power from said alternator to said rechargeable device.

2. The generator assembly of claim 1, wherein said input mechanism includes a pedal system having two pedal shafts each connected to said primary gear such that rotation of said pedal system causes the rotation of said primary gear.

3. The generator assembly of claim 1, wherein said charging mechanism further includes a user interface.

4. The generator assembly of claim 3, wherein said user interface includes an effort indicator having a signaling device indicating whether a user should adjust or maintain a rotation speed of said input mechanism.

5. The generator assembly of claim 3, wherein said user interface comprises a keypad and a display.

6. The generator assembly of claim 5, wherein said display further includes at least one charge rate indicator configured to detect and display an amount of electrical energy being transmitted from said rechargeable interface to each of said at least one rechargeable device.

7. The generator assembly of claim 1, wherein said rechargeable interface comprises at least one charging cable configured to connect to at least one rechargeable device.

8. The generator assembly of claim 1, wherein said alternator is electrically connected to said charging mechanism without an intermediate storage battery.

9-20. (canceled)
